(19) United States
(12) Patent Application Publication
(10) Pub. No.: US 2012/0156667 A1
(43) Pub. Date: Jun. 21, 2012

(54) STRUCTURE AND ADAPTIVE APPARATUS FOR ONLINE EDUCATIONAL LEARNING THROUGH TRUSTED MASS COLLABORATION

(76) Inventor: Gadi Singer, Cupertino, CA (US)

(21) Appl. No.: 12/971,764

(22) Filed: Dec. 17, 2010

(51) Int. Cl. G09B 3/00

(52) U.S. Cl. 434/350

(57) ABSTRACT

A structure and adaptive apparatus for online education learning through trusted mass collaboration. An education server is communicatively coupled to one or more computing devices over a network to provide an online education service. The online education service provides a knowledge structure of K-Courses, K-Lessons, and K-Bits. K-Courses are comprised of more than one K-Lesson. K-Lessons are comprised of more than one K-Bit. Each K-Bit is associated with a plurality of alternative K-Bits to be used as parallel views of the same topic as the associated K-Bit to support student-centric learning. When a student encounters a K-Bit that the student does not understand, one or more alternative K-Bits used as parallel views of the same topic as the associated K-Bit are presented to the student until the student is able to master the topic of the associated K-Bit. The alternative K-Bits used as parallel views of the same topic as the associated K-Bit are sorted based on the student's learning style using a combination of highly adaptive processes.

### BACKGROUND OF THE INVENTION

1. Field of the Invention

The present invention is generally related to an online educational service. More particularly, the present invention is related to a structure and adaptive apparatus for online educational learning through trusted mass collaboration.

2. Description

To solve the problems of today the world needs critical thinkers and problem solvers. The majority of online educational sites are targeted towards teachers. These teacher centric sites include lesson plans, discussions about topics, and networks of teachers for communication and sharing of material. For students there are educational sites on particular topics, but very few with a wide span of knowledge to produce the critical thinkers and problem solvers that are needed today.

### BRIEF DESCRIPTION OF THE DRAWINGS

The accompanying drawings, which are incorporated herein and form part of the specification, illustrate embodiments of the present invention and, together with the description, further serve to explain the principles of the invention and to enable a person skilled in the pertinent art(s) to make and use the invention. In the drawings, like reference numbers generally indicate identical, functionally similar, and/or structurally similar elements. The drawing in which an element first appears is indicated by the leftmost digit(s) in the corresponding reference number.

FIG. 1 is a block diagram illustrating an exemplary environment in which embodiments of the present invention may operate.

FIG. 2 is a block diagram illustrating an online educational service according to an embodiment of the present invention.

FIG. 3 is a block diagram illustrating a knowledge structure for an online educational service according to an embodiment of the present invention.

FIG. 4A is an illustration of an exemplary K-Bit for the Pythagorean Theorem according to an embodiment of the present invention.

FIG. 4B is an illustration of an exemplary parallel view of a K-Bit for the Pythagorean Theorem according to an embodiment of the present invention.

FIG. 4C is an illustration of another exemplary parallel view of a K-Bit for the Pythagorean Theorem according to an embodiment of the present invention.

FIG. 4D is an illustration of another exemplary parallel view of a K-Bit for the Pythagorean Theorem according to an embodiment of the present invention.

FIG. 4E is an illustration of another exemplary parallel view of a K-Bit for the Pythagorean Theorem according to an embodiment of the present invention.

FIG. 5 is an illustration of an exemplary structure of an information page according to an embodiment of the present invention.

FIG. 6 is an illustration of parallel views in the knowledge structure and how K-Bits are used to create K-Lessons and K-Lessons are used to create K-Courses according to an embodiment of the present invention.

FIG. 7 illustrates an exemplary enhancement to guided learning using adaptive searching methods according to an embodiment of the present invention.

FIG. 8 is a block diagram of an exemplary recommender system according to an embodiment of the present invention.

FIG. 9 is a block diagram illustrating a set of parallel evaluation modules according to an embodiment of the present invention.

FIG. 10 is a flow diagram describing an exemplary method for providing individualized, curiously effective K-Bits for learning according to an embodiment of the present invention.

### DETAILED DESCRIPTION OF THE INVENTION

While the present invention is described herein with reference to illustrative embodiments for particular applications, it should be understood that the invention is not limited thereto. Those skilled in the relevant art(s) with access to the teachings provided herein will recognize additional modifications, applications, and embodiments within the scope thereof and additional fields in which embodiments of the present invention would be of significant utility.

Reference in the specification to “one embodiment”, “an embodiment” or “another embodiment” of the present invention means that a particular feature, structure or characteristic described in connection with the embodiment is included in at least one embodiment of the present invention. Thus, the appearances of the phrase “in one embodiment” or “in an embodiment” appearing in various places throughout the specification are not necessarily all referring to the same embodiment.

Embodiments of the present invention are directed to a web-based structure and adaptive apparatus for online educational learning through trusted mass collaboration. In embodiments, the present invention aggregates, structures, and serves knowledge and skills required for grade level K-12 subjects, and enables and encourages the creation of content from a broad community of contributors. This is accomplished by providing a set of web-page templates to capture the various types of educational information, such as, for example, data/informational knowledge and procedural knowledge, and to provide an interactive process of practicing and evaluating the educational information. The web-page template structure allows for the interoperability of pages contributed by multiple sources, thereby supporting collaboration as well as distributed development. The templates encourage use of multimedia and contemporary e-Learning methods to enrich and improve the web-based learning experience and to allow a user to easily navigate and generate customized content contributed from multiple sources.

Embodiments of the present invention also offer multiple views and modalities for every topic to support student-centric learning, i.e., multiple learning styles. This is accomplished by applying a set of adaptive capabilities that allow for personalization of the learning experience for each student. Knowledge is structured in a hierarchical, connected, and user-directed manner that allows for a highly effective construction of educational material. The structure allows for easy re-mixing and mash-ability of content.

Embodiments of the present invention also provide for global, multi-lingual content that addresses a comprehensive list of subjects that is easily extensible. Although the present invention is described as serving knowledge and skills required for grade level K-12 subjects, the invention is not limited to grade level K-12 subjects. In fact, one skilled in the relevant art(s) would know that the present invention may also be extended to college undergraduate, graduate, and post-graduate subjects as well.

Embodiments of the present invention may be implemented using hardware, software, or a combination thereof and may be implemented in one or more multi-core processor platforms or other single-core processing systems. In fact, in one embodiment, the invention is directed toward one or more multi-core processor server platforms or single-core processing server platforms capable of carrying out the functionality described herein.

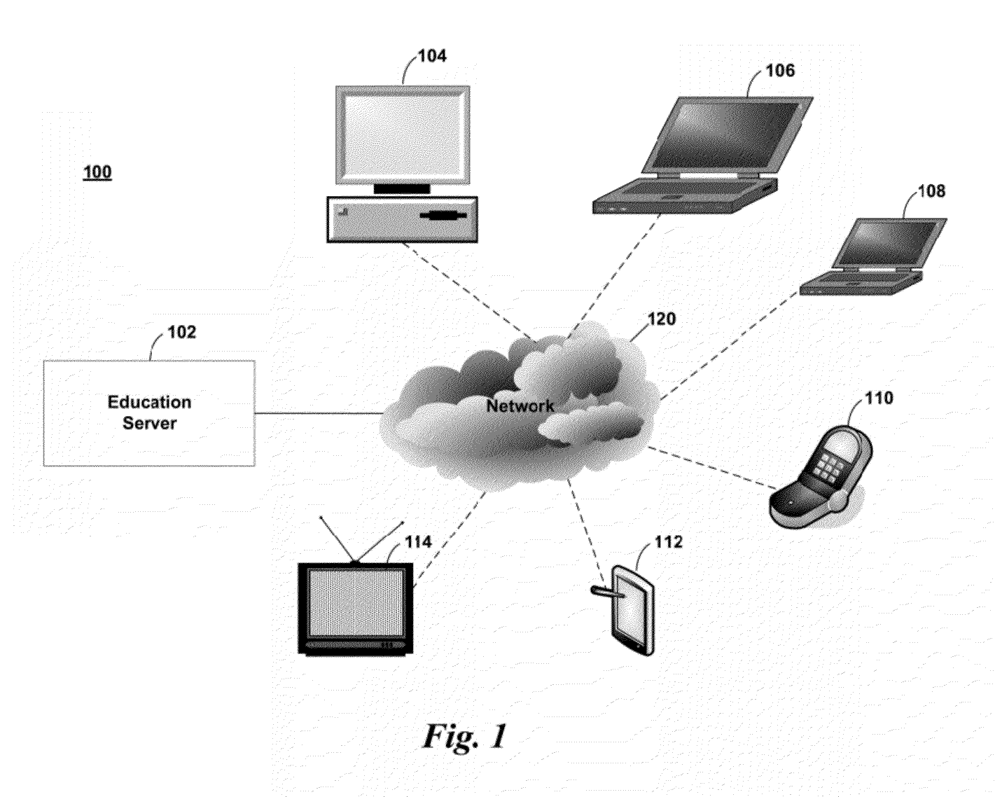

FIG. 1 is a block diagram illustrating an exemplary environment 100 in which embodiments of the present invention may operate. FIG. 1 shows an educational server 102 and various “N” screens (104, 106, 108, 110, 112, and 114) in which a user may connect to educational server 102 via a network 120 using a web-browser, such as, for example, Internet Explorer manufactured by Microsoft® Corporation. In one embodiment, educational server 102 may be a single server. In another embodiment, educational server 102 may consist of multiple servers containing a distributed database managed by each of the multiple servers. Educational server 102 may host the web-based educational system described herein. The various “N” screens are mediums in which a user may connect to the educational server 102 to use the web-based educational service. For example, a user may employ a personal computer (PC) 104, a laptop computer 106, or a netbook computer 108 to connect to the educational server 102 via network 120 using one of a wired or wireless connection. A user may also use a smartphone 110 or a tablet 112 to connect to the educational server 102 via network 120 using a wireless connection. A user may also connect to the educational server 102 via network 120 using a television 114 having wired or wireless network capability. Network 120 may be a wide-area network, such as, for example, the Internet.

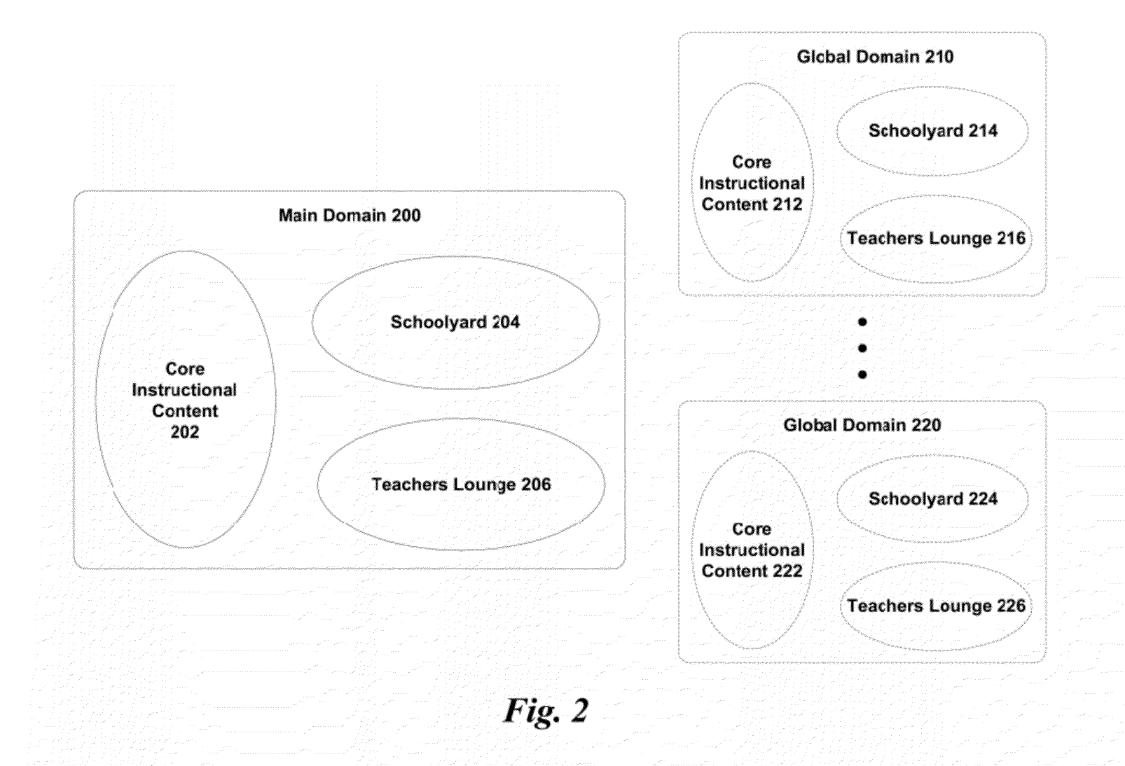

As previously indicated, educational server 102 hosts an online educational service. FIG. 2 is a block diagram illustrating an online educational service 200 according to an embodiment of the present invention. In one embodiment, online educational service 200 may be a web-based system implemented using Web 2.0. In embodiments of the present invention, online educational service 200 aggregates, structures, and serves knowledge and skills to grades K-12. In other embodiments, online educational service 200 may include educational knowledge and skills for grades K-12, college undergraduate, graduate and post-graduate studies.

Online educational service 200 comprises a core instructional content 202, a schoolyard 204, and a teachers lounge 206. The core instructional content 202, also referred to as the educational core, provides safe, instructional materials. The safe, instructional materials comprise approved Knowledge-Bits or K-Bits that have passed a screening process for appropriate, non-offensive, and effective learning. In embodiments of the present invention, the core instructional content 202 is a “safe zone” for approved K-Bits. The core instructional content 202 consists of all aspects of instructional material including text, graphics, video, animation, interactive exercises, practice exercises, simulations, skill reinforcement games, or a combination thereof, and will be described herein.

Schoolyard 204 comprises a domain designed for student interaction, including social network meeting places for student users of online educational service 200. Schoolyard 204 includes narrated chat rooms/discussion boards. In embodiments of the present invention, schoolyard 204 operates under restrictive functionality in a controlled environment to maintain a reasonable level of safety for the students from abuse or predatory actions while connected to online educational service 200. The chat rooms/discussion boards are based on topics, grade levels, and available educators for overseeing/participating in the discussions.

Schoolyard 204 also offers homework help where individuals and groups of individuals are supported. In one embodiment, students are paired with online qualified educators. In one embodiment, students may mail/post questions to online qualified educators for responses/clarifications to those questions.

Teachers lounge 206 comprises a domain for teachers and educational institutions in which K-Lessons and K-Courses created and maintained by educators reside. Educators who create K-Bit instructional material may host the K-Bit in the teachers lounge 206 and link their complementary material to K-Bits in the instructional core content 202. In embodiments in which the teachers lounge 206 may not generally be considered a safe zone, an educator may point a student to their area for K-Courses, K-Lessons, and K-Bits, but inappropriate material in the teachers lounge 206 may be reported by users and offensive pages may be removed.

Extension areas, such as, for example, global domains 210 to 220, may be used by other organizations and/or governments to create an expanded structure for education. For example, another country may create a structure with K-Bits, K-Lessons, and K-Courses of their own to complement the main online educational service 200. In such an instance, the country would own their own core instructional content for K-Bits, schoolyard, and teachers lounge, and may utilize the same type of navigation and other development capabilities as online educational service 200.

In general, since policies and their enforcement for global domains 210 to 220 are managed by third parties, global domains 210 to 220 may not be considered to comply with online educational service 200. However, in embodiments of the present invention, selected domains of global domains 210 to 220 may get a certain level of safety approval if their policies match those of online educational service 200 and are open to auditing for compliance.

In embodiments of the present invention, online educational service 200 structures the knowledge in a manner such that it can be organized and re-constructed to allow support of formal frameworks, such as, for example, school system standards, and allow adaptive capabilities for individualized learning. In many existing K-12 educational web sites and systems, content creation is entrusted to a set of experts and trusted professionals. Embodiments of the present invention shift the centralized role of the experts and trusted professionals from creation of the content to monitoring, filtering, and certification of the content. The experts and trusted professionals may block material that is inappropriate and give credit to material that is of high quality. Thus, online educational service 200 provides experts and trusted professionals with the role of reviewer rather than creator. In embodiments of the present invention, the role of creator is open to the community at large, that is, from any source—professionals, students, parents, and anyone else. Anyone anywhere may add content as long as it meets clear, well-defined acceptance criteria.

Content is screened through a filtering process by authorized experts and trusted professionals chartered by online educational service 200. Submitted material is either added to core instructional content 202 or rejected and blocked from being added to core instructional content 202. The screening rules address appropriateness, accuracy, code safety, and system standards compliance.

Content is deemed appropriate if it is non-offensive. Content accuracy requires the content to be correct and free of gross errors. Code safety requires that the code be free of malicious code, such as, for example, viruses. System standards compliance requires that the content meet technical requirements for page display/interaction and cross-page integration.

In one embodiment, when content meets the requirements of the screening rules, authorized experts and trusted professionals may grade the content based on the quality of the content to indicate their evaluation of the learning effectiveness of the material. The quality grading is considered as an opinion, and may not block the content from being admitted. In one embodiment, when more than one quality grading is provided by the authorized experts and/or trusted professionals, an average grading is reflected. When users search for pages, they may specify the minimum expert's quality grading that they would like to see in the search results.

In embodiments, the present invention balances the openness of community contributions with an effective structure of knowledge. Knowledge is connected, layered and multi-faceted in nature. Online educational service 200 supports the knowledge construct by allowing for data to be represented naturally, connected laterally, and layered hierarchically, and by allowing the same topic to be offered in multiple views. In embodiments of the present invention, knowledge and activities are kept at a basic (atomic) unit of granularity that captures a complete and reasonably context-independent concept/term. The basic units of knowledge, referred to as K-Bits, may be easily assembled and/or stringed together and mixed in a way that is simple to construct, easy to use, and allows for multiple re-combinations of the same basic unit.

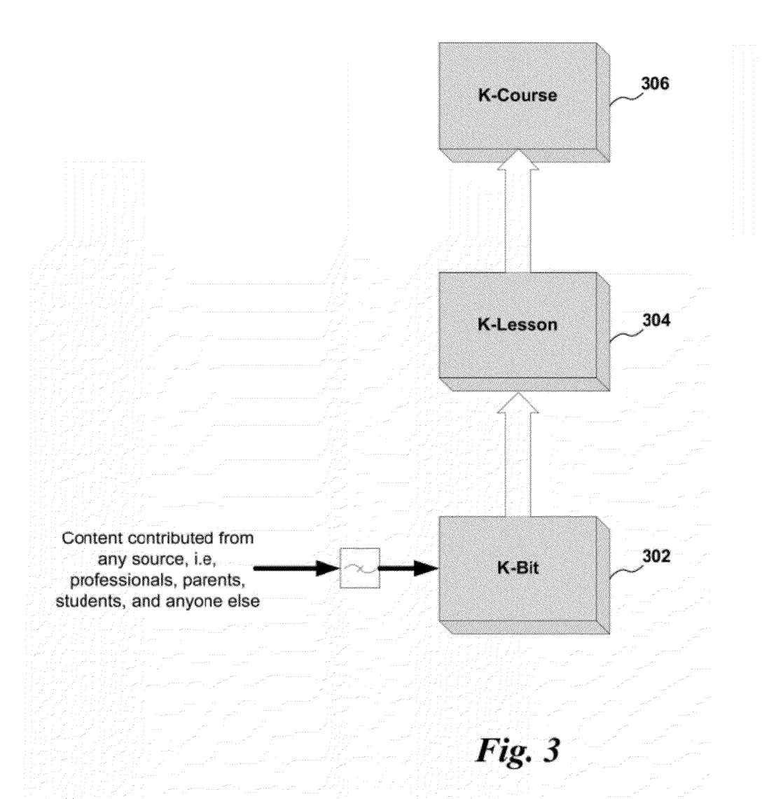

FIG. 3 illustrates a knowledge structure 300 for online educational service 200 according to an embodiment of the present invention. FIG. 3 shows a filter 308, a K-Bit or Knowledge Bit 302, a K-Lesson or Knowledge Lesson 304, and a K-Course or Knowledge Course 306. Filter 308 represents experts and trusted professionals given the responsibility to monitor, filter, and certify content presented to online educational service 200 by the community at large. Thus, before the educational content can be added to the service as a K-Bit, it must be reviewed and accepted by the experts and/or trusted professionals. K-Bit 302 is the basic (atomic) unit of knowledge. K-Lesson 304 represents a lesson comprised of more than one K-Bit 302. K-Course 306 represents a course comprised of more than one K-Lesson 304.

A K-Bit is a particular topic representation. According to embodiments of the present invention, a topic includes a single concept, term, or equation. For example, a single topic may be a term found in an index section of a text book. Examples of mathematical topics may include, but are not limited to, “Complex Numbers”, “Complex Numbers Plane”, “Complex Conjugates”, “Complex Conjugates Theorem”, “Right Triangle”, “Solving a Right Triangle”, “Pythagorean Theorem”, “Converse of the Pythagorean Theorem”, etc. Related, but distinct, topics are separate topics. For example, “Pythagorean Theorem” is a related, but separate topic from “Converse of the Pythagorean Theorem”. On the other hand, particular aspects of specific topics are not considered to be new topics. For example, the topic “Solving a Right Triangle” is not a new topic, but rather a particular K-Bit instantiation of the topic “Right Triangle”.

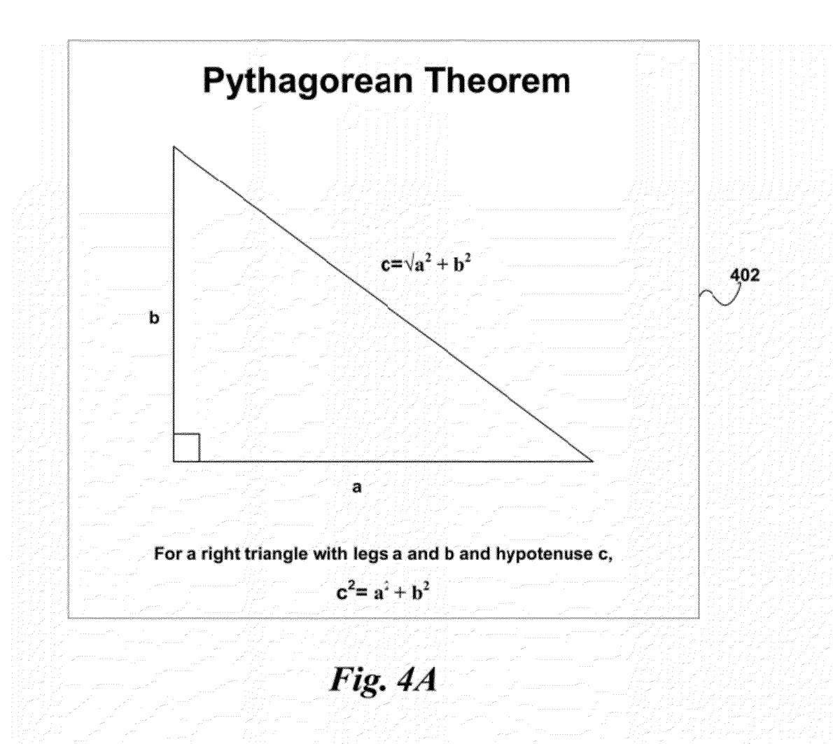

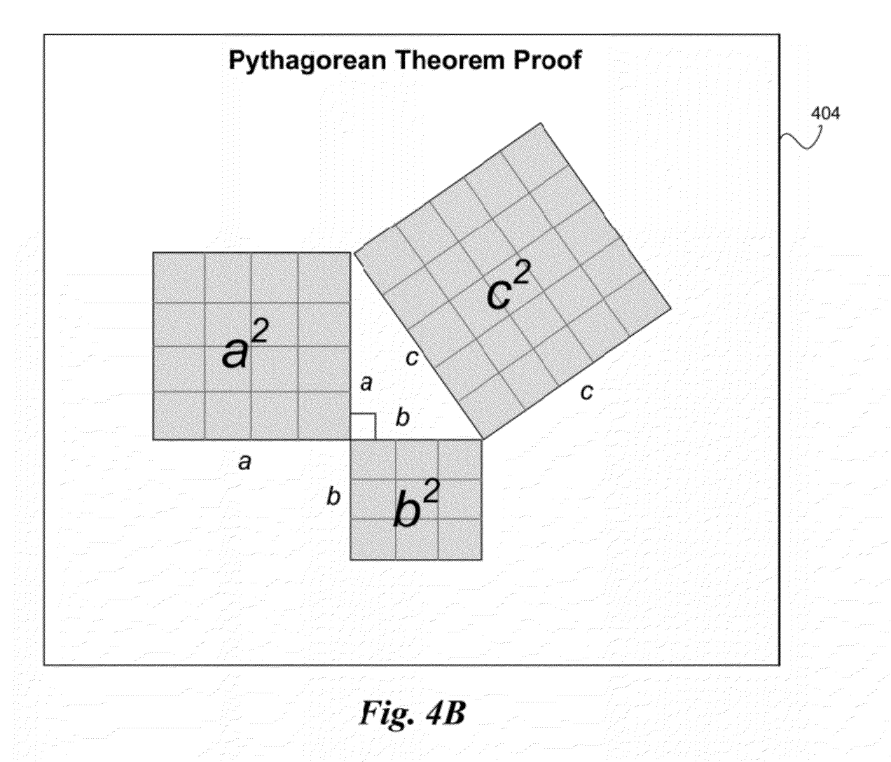

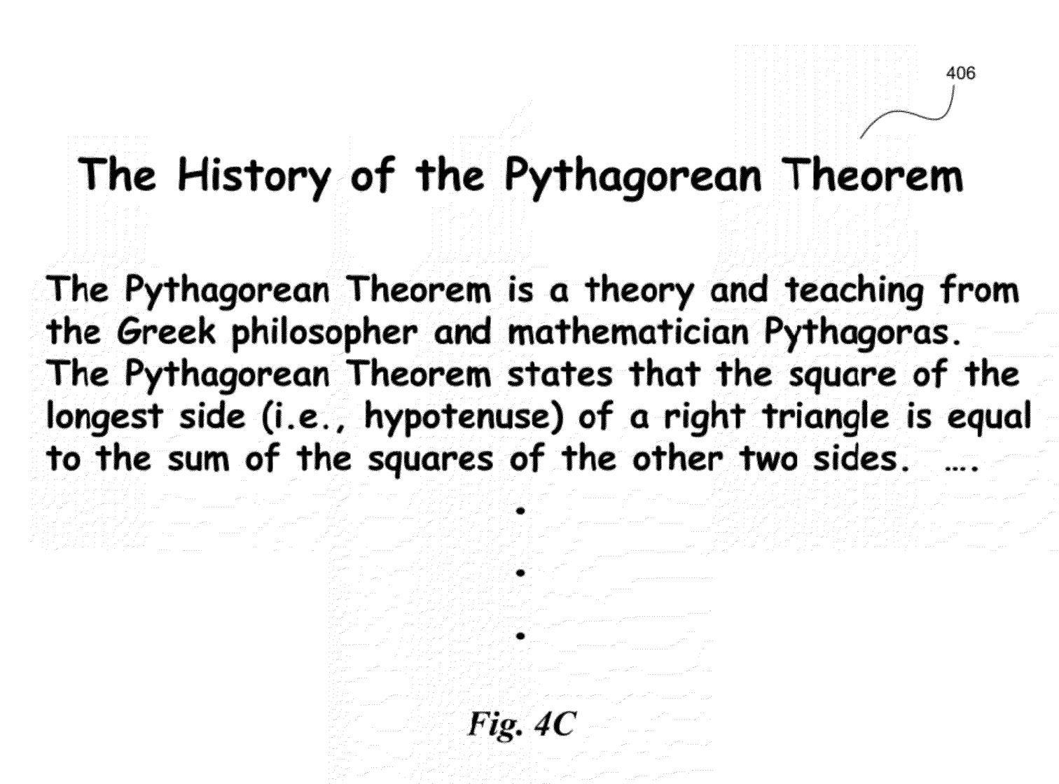

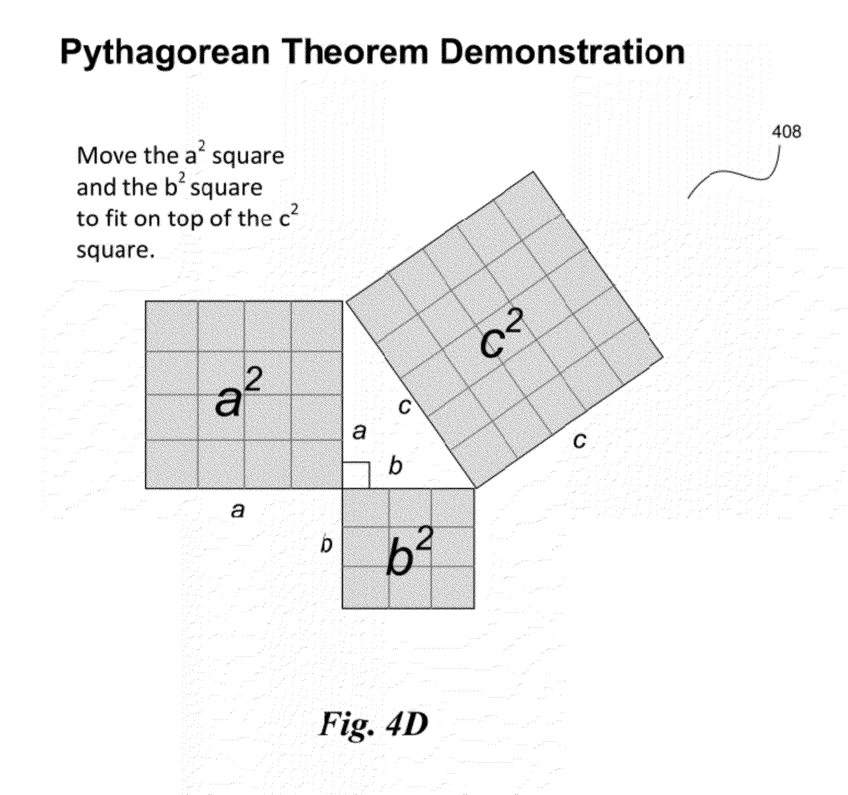

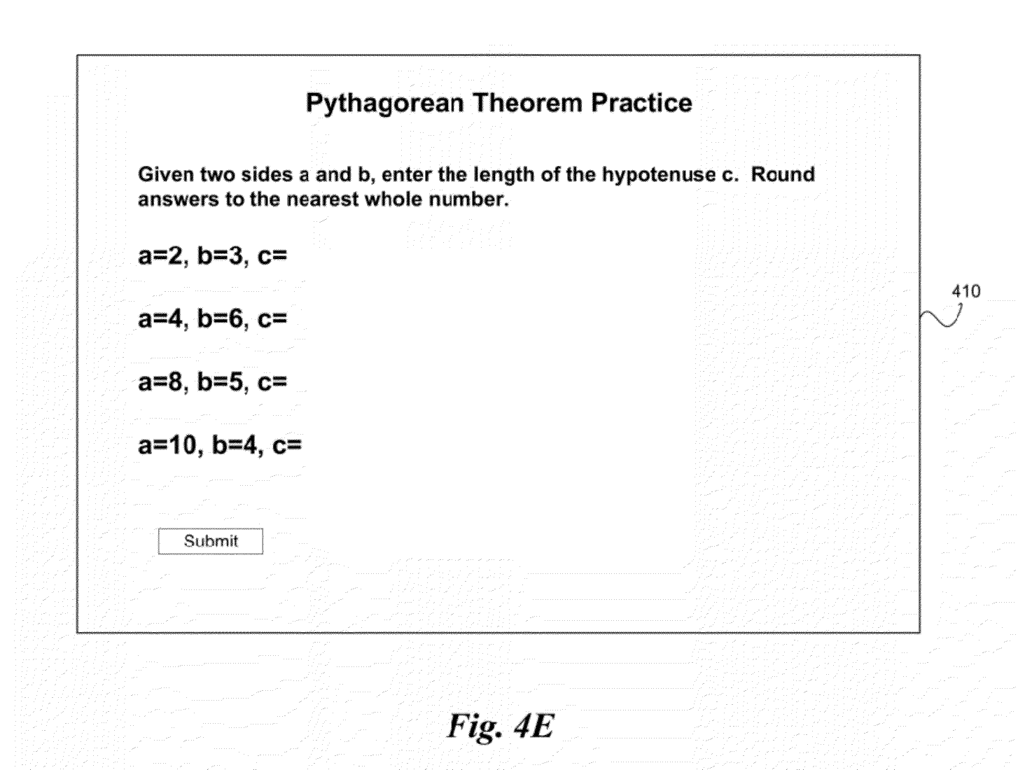

A K-Bit may be an elementary unit of data, such as, for example, a single web page or a single web application, such as, for example a simulator or animation. K-Bit 302 may be as basic as a single paragraph in which a definition of one basic element or a description of one procedural step out of a sequence of steps is defined. K-Bit 302 may be a single diagram or text describing one element of knowledge. K-Bit 302 is not limited to a single element or procedural step. For example, it may also be broader than a single element or procedural step. It may be a full series of steps or a tightly coupled short presentation sequence, that is, a sequence of several slides on the same topic that are structured together as a single K-Bit. For example, as shown in FIG. 4A, a K-Bit for the topic “Pythagorean Theorem” may be the definition of the “Pythagorean Theorem” in textual form and a definition of the “Pythagorean Theorem” illustrated using a diagram. The term “Pythagorean Theorem” is the topic and the particular text page/diagram that represents it is a K-Bit manifestation of the topic.

A K-Bit is associated with a set of attributes. An attribute is a descriptor for the K-Bit. A K-Bit has several classes of attributes. Examples of classes of attributes include, but are not limited to, type, format, category, target age or target grade, language, author, and learning style.

Type attributes are a set of pre-defined descriptors that define the type of K-Bit. Example type attributes may include, but are not limited to, introduction, definition (as shown in FIG. 4A), application, practice, proof, simulation, history, and homework type attributes. New type attributes may be added to the system over time.

Format attributes are a set of pre-defined descriptors that define the format of the K-Bit. Example format attributes may include, but are not limited to, text, video, animation, etc.

Category attributes are a set of pre-defined descriptors that define the subject category of the K-Bit. For example, a subject category attribute may be Math, Science, Languages, etc. Each subject category may include a sub-category attribute. For example, sub-category attributes for Math may include, but are not limited to, addition, subtraction, multiplication, division, algebra, geometry, trigonometry, and calculus. Sub-category attributes for the subject category of Science may include, but are not limited to, general science, biology, chemistry, organic chemistry, and anatomy.

Target age or target grade attributes may be any age range or grade range defined by the content creator of the K-Bit. In one embodiment, age or grade descriptors may be defined as approximate ranges, such as, for example, ages 7 to 9 or grades 5 through 7.

Language attributes define the primary language of the K-Bit.

Author attributes capture the individual name or institution of the creator of the K-Bit. In one embodiment of the present invention, the author attribute may include a channel that introduced the K-Bit, if applicable. A collection of K-Bits, K-Lessons, and/or K-Courses that are created by the same person or entity are referred to as a channel. For example, all of the content (K-Bits, K-Lessons, and/or K-Courses) provided by Intel Corporation may be found on the Intel Channel. In an embodiment of the present invention, channels may also be applied to prolific individual contributors. Channels allow users to identify trusted sources to be followed and preferred. When a user gains confidence and has a preference to a particular source and that source has a channel, that channel may be a preferred source to the user. In one embodiment, online educational service 200 will automatically promote content from that source when available for any search of parallel views to be displayed. In fact, in one embodiment, the user may follow that preferred channel and request notification when new content is posted by the author of that channel.

Learning style attributes are a set of pre-defined descriptors that define the learning style of the K-Bit. Exemplary learning style attributes include, but are not limited to, VARK (Visual/Auditory/Reading-writing/Kinesthetic) properties.

In embodiments of the present invention, a system-generated attribute may include, but is not limited to, popularity. The popularity attribute is based on the number of visits to a K-Bit as well as user favorite K-Bits.

As previously indicated, FIG. 4A is an illustration of an exemplary Definition K-Bit for the Pythagorean Theorem according to an embodiment of the present invention. Definition K-Bit 402 defines the Pythagorean Theorem using text, a diagram, and equations. The diagram is representative of the Pythagorean Theorem equation components.

In an embodiment of the present invention, the same topic may have a plurality of K-Bits. For example, the topic “Pythagorean Theorem” may have many different K-Bits associated with it. The different K-Bits may provide alternate representations of the topic “Pythagorean Theorem”. In other words, different K-Bits for the same topic provide alternate ways to capture the same topic as well as provide alternate ways to enable a student to master the topic of the K-Bit. The different K-Bits may be represented in different formats, such as, for example, text, video, animation, etc.

In embodiments of the present invention, all views of a particular topic/term are referred to as parallel views. Often times the parallel views represent the topic using different attributes, such as, for example, different type attributes, different format attributes, etc. FIGS. 4B-4E are exemplary parallel views of the Definition K-Bit for the “Pythagorean Theorem” shown in FIG. 4A. FIG. 4B is an exemplary Learn K-Bit 404 of an animated proof of the “Pythagorean Theorem” according to an embodiment of the present invention. The type attribute for K-Bit 404 is a learn attribute. The format attribute for K-Bit 404 is an animation format. FIG. 4C is an exemplary History K-Bit 406 for the “Pythagorean Theorem” according to an embodiment of the present invention. The type attribute for the K-Bit 406 is a history attribute. The format attribute for K-Bit 406 is text. K-Bit 406 provides a history overview of the “Pythagorean Theorem”. FIG. 4D is an exemplary Simulation K-Bit 408 for users to prove the “Pythagorean Theorem” according to an embodiment of the present invention. The type attribute for K-Bit 408 is a simulation attribute. The format attribute for K-Bit 408 is text and a diagram. K-Bit 408 allows users to prove the “Pythagorean Theorem” by clicking and dragging the ‘a²’ square and the ‘b²’ square to fit perfectly on top of the ‘c²’ square. FIG. 4E is an exemplary Practice K-Bit 408 for the “Pythagorean Theorem” according to an embodiment of the present invention. The type attribute for K-Bit 410 is a practice attribute. The format attribute for K-Bit 410 is text. K-Bit 410 provides an interactive practice quiz that allows users to verify their understanding of the “Pythagorean Theorem”. Additional parallel views for the Pythagorean Theorem topic may include, but are not limited to, a video of a teacher explaining the Pythagorean Theorem, video describing the origin of the Pythagorean Theorem, an overview of the Pythagorean Theorem in another language, such as, for example, Spanish, etc.

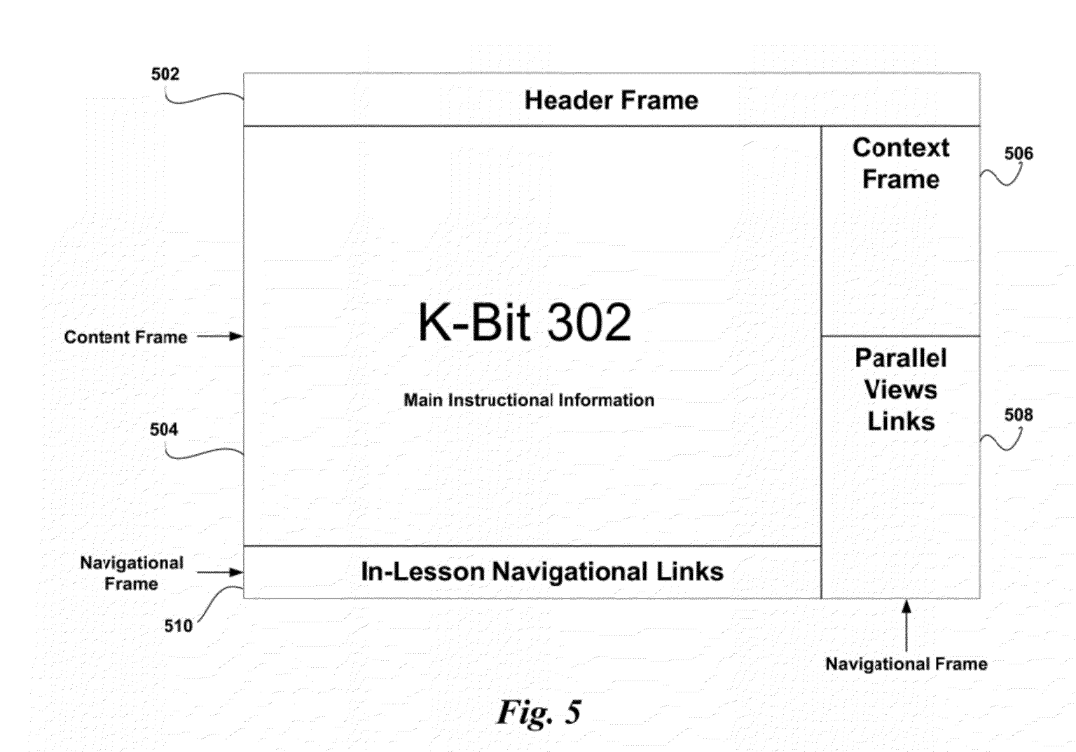

In embodiments of the present invention, K-Bits 302 are provided within an information page when presented to a viewer. In one embodiment, when a user views an information page, five types of information are visible to the user. FIG. 5 illustrates an exemplary structure of an information page 500 according to an embodiment of the present invention. Information page 500 comprises a header frame 502, a content frame 504, a context frame 506, a parallel views frame 508, and an in-lesson navigation frame 510.

Header frame 502 provides header information. In one embodiment, header frame 502 may include a link back to the home page.

Content frame 504 displays a K-Bit 302 having the main instructional information. As previously described, K-Bit 302 may include text, graphics, video, animation, interactive practice exercises, simulation, skill-reinforcement games, or a combination thereof. In one embodiment, K-Bit 302 may have embedded hypertext links that lead to other K-Bits. For example, within a definition K-Bit defining “Ohm's Law” there may be a link to another definition K-Bit defining the term “Voltage”.

Context frame 506 may contain information pulled from meta-data of K-Bit 302 currently in content frame 504. Context frame 506 may also contain contextually-related options available to the user. Data specific to K-Bit 302 meta-data may include the K-Bit title, description, user-aggregated ratings, and view count (i.e., the number of times the K-Bit has been viewed). In an embodiment of the present invention, a “Good for You” rating may be included in context frame 506. The “Good for You” rating relates the effectiveness of K-Bit 302 to the learning style of the user. In one embodiment, the “Good for You” rating may have a rating of 1-5 with 1 indicating a perfect match and 5 indicating a non-match. In yet another embodiment, a rating of 5 may indicate a perfect match while a rating of 1 indicates a non-match for the user. Contextual options for the user may include, but are not limited to, a K-Bit rating, a thumbs up marking, a favorite marking, a flagging for review marking.

Parallel views frame 508 comprises links in the form of icons or text attributes that point to alternate parallel views of the same K-Bit 302. For example, there may be a link to a video demonstrating “Ohm's Law” and another link to interactive practice exercises on the topic of “Ohm's Law. In the case of the Definition K-Bit 402 for the Pythagorean Theorem shown in FIG. 4A, links may be provided for Learn K-Bit 404 for the Pythagorean Theorem (FIG. 4B), History K-Bit 406 for the Pythagorean Theorem (FIG. 4C), Simulation K-Bit 408 for the Pythagorean Theorem (FIG. 4D), and Practice K-Bit 410 for the Pythagorean Theorem (FIG. 4E).

Returning to FIG. 3, the primary objective of, K-Lesson 304 is to provide a pre-selected sequence of K-Bits 302 that guides the student through a specific learning sequence. Thus, K-Lesson 304 comprises more than one K-Bit. K-Lesson 304 is a collection of instructional K-Bit data and activities that together form a complete lesson for a particular topic. K-Lesson 304 is a structure page or navigational structure. K-Lesson 304 does not contain the instructional material. Instead, K-Lesson 304 comprises a description of a lesson and hypertext links to a selected set of K-Bits. The set of K-Bits typically include, but are not limited to, one or more pages presenting the material and one or more practice/exercise pages. In one embodiment, a K-Lesson comprises a complete sequence of linked screens that cover a topic, plus the review and test tabs. K-Lessons may be constructed by teachers, educational institutions, and other professionals. K-Lessons reside outside of the “safe zone” of online educational service 200. Criteria for maintaining a K-Lesson page is that the K-Lesson be appropriate and non-offensive. This is monitored by the users of online educational service 200. If a user finds a K-Lesson to be inappropriate and/or offensive, the user may report this to online educational service 200.

In addition to a sequence of K-Bits, each K-Lesson 304 includes tabs that are accessible from the K-Lesson viewing page. In one embodiment, three tabs are used for providing a lesson plan, information about the author, and a comments/discussion area. The lesson plan provides a place for associated pedagogical information for the lesson and other detailed information meant to help other educators in using the K-Lesson and integrating the K-Lesson into their class. The lesson plan is also used to link the selected K-Bits and the topic covered to applicable educational standards, such as, for example, the educational standards for the state of Pennsylvania (i.e., the Pennsylvania State Standards). Information about the author includes information from the K-Lesson creator profile that provides some background about the creator. If applicable, a link to the creator's channel may also be provided. The comments/discussions' area is a place where other users can provide reviews, post questions, and relay their experiences in using the K-Lesson. In one embodiment, the comments may be threaded as in a discussion board and may be deleted by the creator of the K-Lesson.

Returning to the in-lesson navigation frame 510 of the information page in FIG. 5, in-lesson navigation frame 510 may contain a set of buttons referred to as “In-Lesson Player”. The in-lesson player allows a user to seamlessly follow the prescribed sequence of K-Bits within a K-Lesson. When a user goes into a K-Lesson, in-lesson navigation frame 510 includes navigation frame buttons for “Next”, “Previous”, “First”, and “Last” K-Bit within that K-Lesson. Following the prescribed sequence of K-Bits keeps the user within the safe zone.

In embodiments of the present invention, the same K-Bit 302 may be reached from different K-Lessons 304. In this case, the navigation frame buttons reflect the K-Lesson sequence from which K-Bit 302 was reached. When K-Bit 302 is displayed as a result of a search, that is, not from K-Lesson 304, the in-lesson navigation frame 510 is not active.

Returning to FIG. 3, K-Courses 306 are used to structure a sequence of K-Lessons 304. K-Course 306 may be designed to map between a full curriculum and individual K-Lessons 304. Each K-Course 306 may include a tab for standards that provide tools for mapping each of K-Lessons 304 in K-Course 306 to the corresponding standards to see the correlation and completeness of the set of K-Lessons 304 to a full curriculum. The mapping between K-Courses 306, K-Lessons 304, and K-Bits 302 allow for an overall mapping between a structured school district (or state or country) formal set of standards and the sea of knowledge represented by the full database of K-Bits.

As previously indicated, parallel views are multiple K-bits associated with the same topic/term. Each topic or term within the online educational service 200 may have multiple K-bits associated with it that represent alternate ways to capture the same topic or term. Parallel views may be of the same type, for example, multiple alternate text-based descriptions of the same topic, or of different types, for example, text views, videos, practice views, and simulations of the same topic.

In embodiments of the present invention, knowledge is represented in a modular manner that allows a very broad array of teaching and learning paths. Online educational service 200 structures the diversity of representation at every level of the data constructs—from the basic K-Bit 302 to the multiple K-Lessons 304 that may build on the same topic to the unlimited number of K-Courses 306 that may be constructed for the same material. Parallel views provide this multiple-faceted support at the K-bit level. Embodiments of the present invention encourage as many representations of the same topic as the contributors of content are willing and able to create. K-Bits 302 are encouraged to target different learning styles and multiple modalities to provide the broadest set of representations for any single topic or term. To achieve guaranteed understanding of a topic by each student, online educational service 200 encourages the contribution of many competing views for the same term or topic with the expectation that the competing views will increase the likelihood of having a representation that works to provide the student with a complete understanding of the topic.

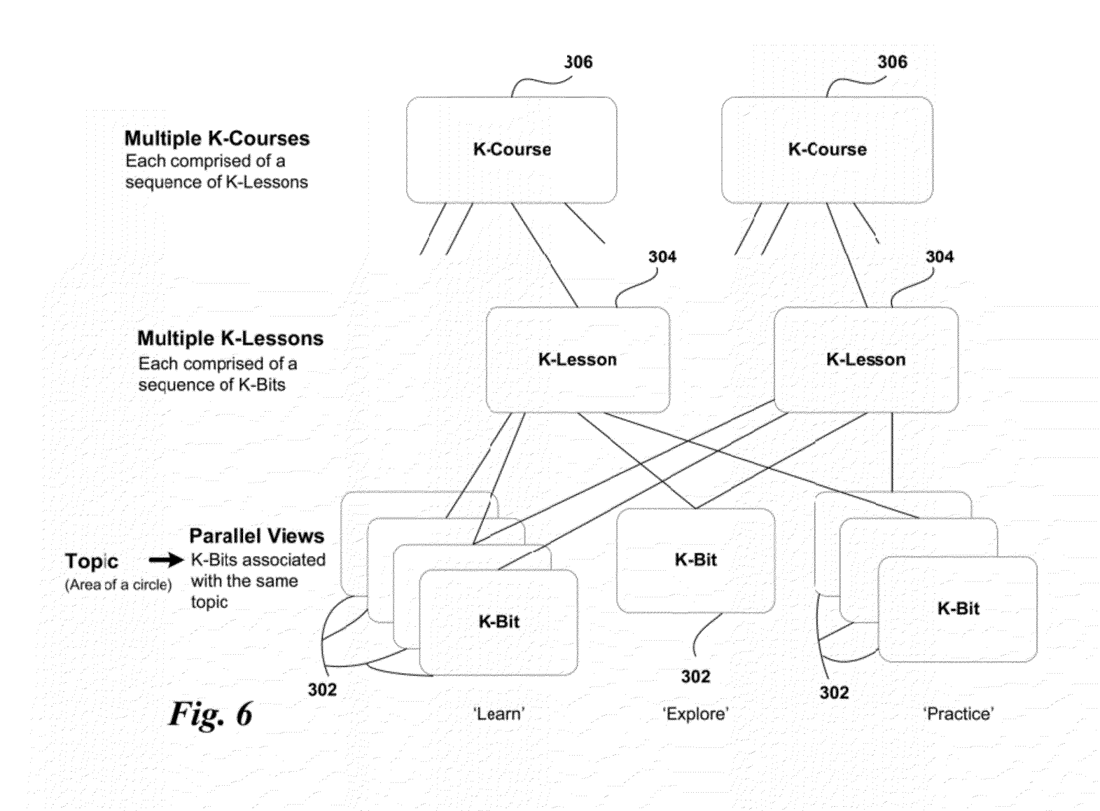

FIG. 6 is an illustration of parallel views in the knowledge structure and how K-Bits 302 are used to create K-Lessons 304 and K-Lessons 304 are used to create K-Courses 306 according to an embodiment of the present invention. As shown in FIG. 6, the exemplary topic is an area of a circle. Parallel views of K-Bits 302 associated with the same topic (area of a circle) are presented as a plurality of ‘learn’ K-Bits 302, one ‘explore’ K-Bit 302, and a plurality of ‘practice’ K-Bits 302. The learn K-Bits 302 may include general descriptions of the area of a circle and the history of an area of a circle and how it was first introduced. The explore K-Bit 302 may include an interactive exercise showing the practical use of the topic. The practice K-Bits 302 may include exercise questions that allow for practicing and assessing an understanding of the topic. In one embodiment, K-Bits 302 may include java applets that allow open-ended experimentation on the area of a circle.

Two K-Lessons 304 are shown, each being a lesson for the area of a circle. Each of K-Lessons 304 are comprised of a sequence of K-Bits 302, yet each of K-Lessons 304 include some of the same K-Bits 302 as well as some different K-Bits 302. Multiple K-Courses may also be comprised of a sequence of K-Lessons, but not necessarily the same sequence of K-Lessons.

The variety and multitude of parallel views for any given topic allow for a very broad array of teaching and learning methodologies. The knowledge structure of embodiments of the present invention enable user-based creation of instructional material that is as varied as the user base and as effective as the imagination of the contributing community.

In embodiments of the present invention, online educational service 200 uses pre-defined K-Lessons 304 to guide students through a specific sequence of material (K-Bits 302) on any given topic. Each topic in a K-Lesson 304 includes parallel views to provide alternative representations of the same topic in the guided sequence. The parallel views, selected by the online educational service 200, use a profile of the current student and analysis of the whole space of K-Bits to provide highly personalized teaching based on student preferred sources, preferred learning style, quality expectations, etc.

A user of the system can reach a K-Bit either through following a pre-defined sequenced K-Lesson that incorporates that K-Bit as described above or through adaptive search of the associated topic.

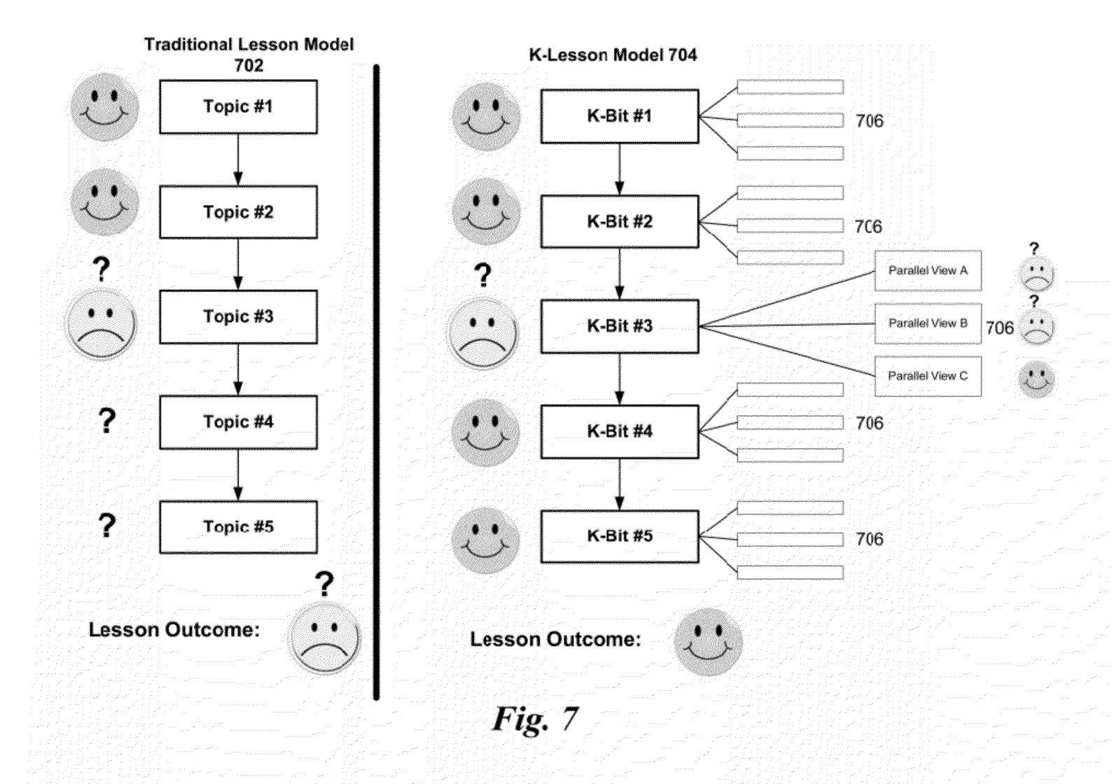

FIG. 7 illustrates an exemplary enhancement to guided learning using adaptive searching methods according to an embodiment of the present invention. The left side of FIG. 7 shows a traditional lesson model 702 that does not take advantage of the system adaptive searching techniques and the right side shows a K-Lesson model 704 utilizing adaptive searching techniques.

The lesson model without adaptive searching shows a guided navigational lesson model having 5 topics. Each topic requires an understanding of the previous topic, with the exception of the first topic, to enable the student to grasp the current topic. In other words, the learning sequence of topics requires an understanding of a current topic in order to master the next topic in the sequence. Note that the student has mastered the first two topics, which is shown as a smiley face. When the student progresses to the third topic, the student in this example is confused (shown with a frowned face and a question mark). The student does not have an understanding of topic #3, and therefore, cannot understand topics #4 and #5. Thus, the lesson outcome for lesson model 702 is one that leaves the student confused. Thus, the lesson model 702 does not provide an effective lesson for the current student because the current student was unable to grasp the teachings of topic #3, and therefore, could not grasp the teachings of topics #4 and #5.

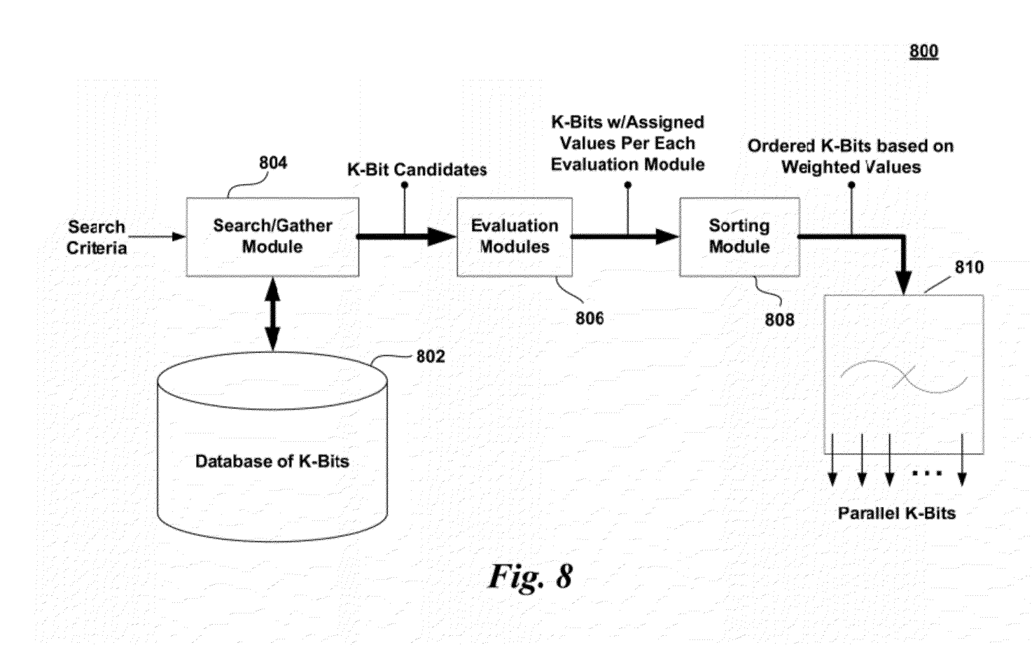

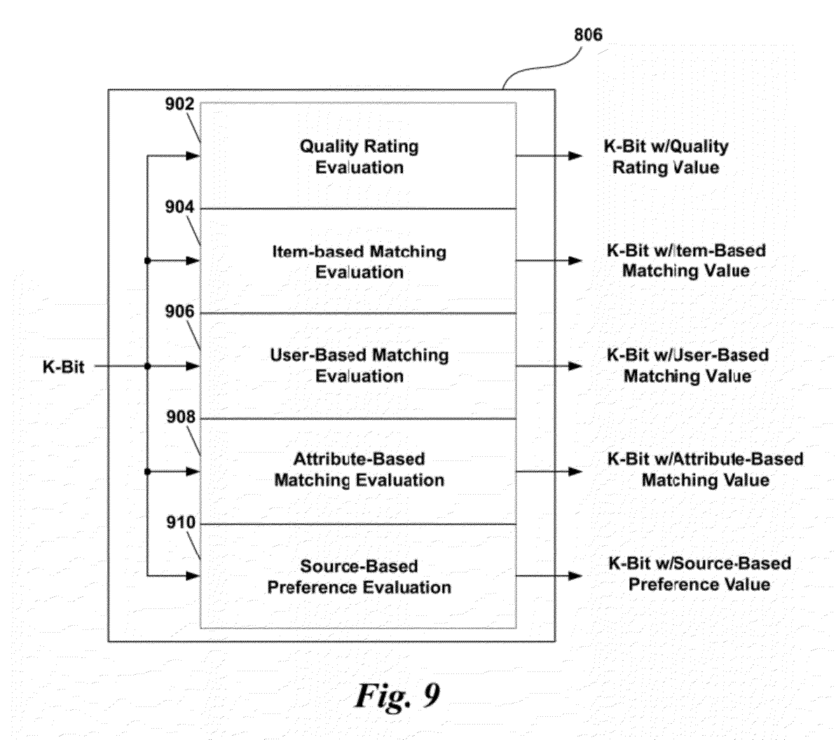

Embodiments of the present invention strive for guaranteed understanding of each topic in a K-Lesson 304. This is accomplished using parallel views for each topic in K-Lesson 304, with the expectation being that the parallel views increase the likelihood of having a K-Bit 302 that provides the student with a complete understanding of the topic. The parallel views for each topic are identified and selected by online educational service 200 based on a best match and highest value to the student. The best match and highest value to the student are determined using a recommender system, which is described below with respect to FIGS. 8 and 9.

The right side of FIG. 7 shows a guided learning K-Lesson model enhanced with adaptive searching according to an embodiment of the present invention. When a student follows the navigation of K-Lesson model 704, the student is provided with a guided sequence of K-Bits pre-defined for the student by a teacher and/or creator of the K-Lesson (guided learning). Each K-Bit in K-Lesson model 704 includes a pane of parallel views 706. The K-Bits presented in the pane of parallel views 706 are a result of an automatic search using attributes of the pre-defined K-Bits in the K-Lesson as a base to look for other representations of K-Bits in the overall database. The selection of K-Bits in the pane of parallel views 706 is based on results from the recommender system, which evaluates the best match of material (K-Bits) to the particular student using K-Lesson model 704.

As shown, the student follows the guided path sequence of K-Bits #1 and #2 with a good understanding of the K-Lesson (shown with a smiley face). When the student reviews K-Bit #3, the student is confused (shown by the frowned face and question mark). The student may then review the parallel views until the student finds a parallel view that enables the student to grasp the concept being taught by K-Bit #3. In the instance shown in FIG. 7, the student has grasped the concept with the review of the K-Bit 302 displayed in parallel view C. The student can then return to the guided path sequence of K-Bits (K-Bit #4) in the K-Lesson model 704 to continue the K-Lesson model 704. As shown, the student is able to complete K-Lesson model 704 with a positive outcome. Although three parallel views are shown for each K-Bit in FIG. 7, the invention is not limited to three parallel views. In embodiments of the present invention, if a student following the guided path reaches a K-Bit that the student does not understand, the student can select from the pane of parallel views as many K-Bits as needed to understand the difficult subject matter. Once the concept of the difficult subject matter is understood, the student may return to the original K-Lesson sequence by selecting a return button.

In embodiments of the present invention, being able to identify and present parallel views of K-Bits that provide the best match and highest value to a particular student is a major factor in providing highly effective individualized learning. The quality and effectiveness of the K-Bits presented as parallel views for a particular student are key to providing highly effective learning with the online educational service.

Almost every response to a student's interaction with online educational service 200 includes some form of a recommended list of K-Bits. A response to a direct search on a term or source results in a search result set. In addition, every display of a K-Bit is also associated with a sorted list of parallel views. In both cases, there is an information filtering function that examines the student's request and provides a selection of K-Bits that are aimed at best meeting the student's learning preferences and learning objectives.

Structured and prioritized K-Bits are provided by a combination of a direct search matching system and a Recommender System. The search portion is relatively straight forward and well known to those skilled in the relevant art(s), that is, matching terms in a search query to indexing of the information units in the system. The information units include K-Bits. In the case of a parallel views list, the term of a current displayed K-Bit defines what is being matched to indexing of the K-Bits in the system. For example, if the student is looking at a K-Bit for the Pythagorean Theorem, the search term will be Pythagorean Theorem and the top set of K-Bit results will appear as the K-Bit list of parallel views.

To enrich the results and create a better personalization of the learning process, the results of the search portion are guided and intermixed with suggested items from the recommender system.

In embodiments of the present invention, the recommender system compares the user's profile to some reference characteristics, and seeks to predict a rating that a user would give to an item they have not yet considered. These characteristics may be from the information item, which is the content-based approach, or the user's social environment, which is the collaborative filtering approach.

Collaborative filtering (CF) is a process of filtering for information or patterns using techniques involving collaboration among multiple agents, viewpoints, data sources, etc. It makes automatic predictions (filtering) about the interests of a user by collecting preference information from many users (collaborating). The underlying assumption of the CF approach is that those who agreed in the past tend to agree again in the future. For example, collaborative filtering or recommendation system for music preferences could make predictions about which music a user may like given a partial list of that user's music likes or dislikes. These predictions are specific to the user, but use information gleaned from many users. This differs from the simpler approach of giving an average (non-specific) score for each item of interest, for example, based on its number of votes.

FIG. 8 is a block diagram of an exemplary recommender system according to an embodiment of the present invention. Recommender system 800 comprises a database 802, a search/gathering module 804, evaluation modules 806, a sorting module 808, and a filter 810. Database 802 is coupled to search/gather module 804. Search/gather module 804 is coupled to evaluation modules 806. Evaluation modules 806 are coupled to sorting module 808. Sorting module 808 is coupled to filter 810.

Search/gathering module 804 searches database 802 for K-Bits that fit the search criteria used and identifies all potential matches. If it is a basic search for K-Bits, the search criteria are derived from the topic of interest. If the search is to identify parallel views for a displayed K-Bit, the search criteria include the topic and attributes of the displayed K-Bit. For example, if the displayed K-Bit comprises the Pythagorean Theorem for 6-to-8 grade with an attribute of “History”, these details may be given as the search criteria. The search is a database query on all of the K-Bits in the database. The output of search/gathering module 804 is a list of K-Bit candidates to be evaluated by evaluation modules 806.

Evaluation modules 806 are comprised of a set of parallel modules to analyze each K-Bit from the list of K-Bit candidates delivered by search/gathering module 804. Each evaluation module assigns a value to each K-Bit candidate. The output from evaluation modules 806 comprises the input list with every K-Bit candidate having values assigned by each of the evaluation modules 806.

FIG. 9 is a block diagram illustrating a set of parallel evaluation modules 806 according to an embodiment of the present invention. The set of parallel evaluation modules 806 comprises a quality rating evaluation module 902, an item-based matching evaluation module 904, a user-based matching evaluation module 906, an attribute-based matching evaluation module 908, and a source-based preference evaluation module 910.

Quality rating evaluation module 902 provides an accumulated average quality grading score of two systems of grading. The first system of grading is a user grading system, where users of online educational service 200 may rate a K-Bit that they have utilized. The second system of grading is an expert grading system, where certified system experts provide ratings for the K-Bits.

Item-based matching evaluation module 904 comprises an inter-item matrix that determines relationships between pairs of K-Bits that were selected by the same users. This item-based collaboration filtering is similar to “users who bought x also bought y” used by many web site retailers.

User-based matching evaluation module 906 identifies other users that have general rating and selection patterns similar to the active user performing the search. Module 906 provides a predictive value to the evaluated K-Bit based on the choices of these other users.

Attribute-based matching evaluation module 908 assesses the match between the attributes of the evaluated K-Bit, the criteria of the search, and the profile of the active user. Module 908 determines a learning style preference of the active user, such as, for example, visual vs. auditory, and big-picture vs. step-by-step. Module 908 also determines a type match, such as, for example, a history attribute for parallel K-Bits of a displayed history K-Bit.

Source-based preference evaluation module 910 assigns increased value to preferred sources of content. For example, in one embodiment when the active user explicitly chooses a preferred source channel, such as the Intel channel or the BBC channel, a K-Bit from the preferred source channel may be assigned an increased value. In one embodiment, an increased value may be assigned for implicit choices based on past selections like, for example, always starting with and highly grading Skoool K-Bits.

Returning to FIG. 8, sorting module 808 receives the list of candidate K-Bits with values from each evaluation module 902-910 and sorts the list into a prioritized list presentation. In one embodiment, the sorting comprises assigning weights to each of the results of evaluation modules 902-910, and ordering the K-Bits based on their weighted overall value. In another embodiment, more sophisticated sorting algorithms may be evaluated. For example, taking into account that sometimes a specific learning style is more suitable to a particular topic, not just an individual student, the sorting may intermix items based on their rating with items based on the active user matching to ensure that one factor does not overwhelm any other through the weighting.

Filter 810, also referred to as a screening module, eliminates any K-Bits from the list that are violating any specific acceptance criterion. For example, “must have” criteria may be the following:

Language (for example, results should only be in English);

General Quality Grading (for example, a rating of 3 or more out of 5)

Specific Certification (for example, Pennsylvania Academic Board Certified).

Any K-Bits that violate any of the above criteria may be eliminated from the final list.

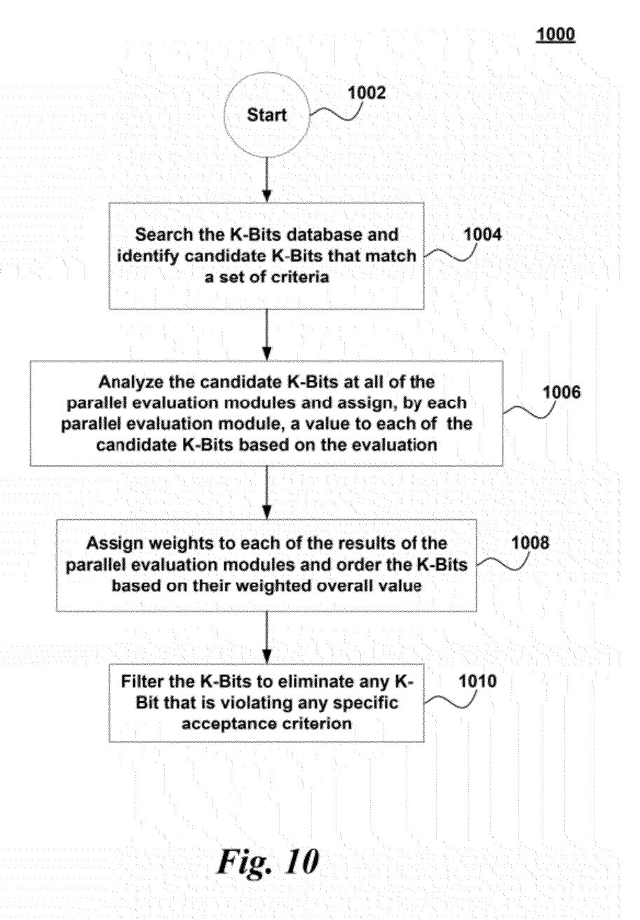

FIG. 10 is a flow diagram 1000 describing an exemplary method for providing individualized, curiously effective K-Bits for learning according to an embodiment of the present invention. The invention is not limited to the embodiment described herein with respect to action flow diagram 1000. Rather, it will be apparent to persons skilled in the relevant art(s) after reading the teachings provided herein that other functional action flow diagrams are within the scope of the invention. The process begins at 1002, where the process immediately proceeds to block 1004.

In block 1004, the K-Bit database is searched according to a set of criteria to obtain a list of K-Bits matching the set of criteria. If a basic search is being performed, the search criteria are derived from the search command. If online educational service 200 is identifying parallel views for a displayed K-Bit, the search criteria includes the topic of the K-Bit and attributes of the displayed K-Bit. The output from the search results in a list of K-Bit candidates. The process then proceeds to block 1006.

In block 1006, each K-Bit candidate is analyzed and evaluated by five separate and distinct parallel modules and assigned a value by each of the five parallel modules. The analysis and evaluation includes a quality rating by users and certified system experts; a determination between pairs of K-Bits that were selected by the same users; identification of other users that have general rating and selection patterns similar to the active user doing the research to provide predictive value to the evaluated K-Bit based on the choices of the other users; assessment of a match between the attributes of the evaluated K-Bit, the criteria of the search, and the profile of the active user; and assigning increased value to K-Bits from preferred sources. The output from block 1006 comprises the input list of K-Bits with every K-Bit having values assigned by each of the five parallel modules. The process then proceeds to block 1008.

In block 1008, the K-Bits are sorted into a prioritized list. The sorting is performed by assigning weights to each of the results of the evaluation modules 806 and ordering the K-Bits based on their weighted overall value. In another embodiment, the sorting may intermix K-Bits based on their rating with items based on the active user matching to ensure one factor does not overwhelm the other through the weighting. The process then proceeds to block 1010.

In block 1010, the K-Bits are filtered to eliminate all K-Bits that violate specific criterion. The remaining K-Bits are displayed as results of the search.

Embodiments of the present invention may be implemented using hardware, software, or a combination thereof and may be implemented in one or more computer systems, such as, for example, server 102 and computing devices 104, 106, 108, 110, 112, and 114 as shown in FIG. 1, or other processing systems. The techniques described herein may find applicability in any computing, consumer electronics, or processing environment. The techniques may be implemented in programs executing on programmable machines such as mobile or stationary computers, personal digital assistants, set top boxes, cellular telephones and pagers, consumer electronics devices (including DVD (Digital Video Disc) players, personal video recorders, personal video players, satellite receivers, stereo receivers, cable TV receivers), and other electronic devices that may include one or more processor core(s), a storage medium accessible by the processor core (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that the invention can be practiced with various system configurations, including multiprocessor systems, minicomputers, mainframe computers, independent consumer electronics devices, and the like. The invention can also be practiced in distributed computing environments where tasks or portions thereof may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine-readable medium (or tangible computer-readable medium or article) having stored thereon instructions that may be used to program a processing system or other electronic device to perform the methods. The term “machine readable medium” or “article” used herein shall include any medium that is capable of storing or encoding a sequence of instructions for execution by the machine and that cause the machine to perform any one of the methods described herein. The term “machine-readable medium” or “article” may accordingly include, but not be limited to, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. Furthermore, it is common in the art to speak of software, in one form or another (e.g., program, procedure, process, application, module, logic, and so on) as taking an action or causing a result. Such expressions are merely a shorthand way of stating the execution of the software by a processing system to cause the processor to perform an action or produce a result.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

What is claimed is:

1. An education system, comprising:
one or more education servers communicatively coupled to a plurality of computing devices over a network to provide an online education service to the plurality of computing devices, the online education service having a knowledge structure comprised of one or more knowledge courses (K-Courses), the one or more K-Courses comprised of more than one Knowledge Lessons (K-Lessons), the K-Lessons comprised of more than one Knowledge Bit (K-Bit), wherein the K-Bit comprises a basic unit of knowledge.

2. The education system of claim 1, wherein a basic unit of knowledge comprises a single topic having one of a single concept, term, or equation.

3. The education system of claim 1, wherein the K-Bit is associated with a set of attributes, the set of attributes comprising a type attribute to define the type of the K-Bit, a format attribute to define the format of the K-Bit, a category attribute to define the subject category of the K-Bit, a target grade to define the appropriate grade level of the K-Bit, a language attribute to define the primary language of the K-Bit, an author attribute to define the creator of the K-Bit, a learning style attribute to define the learning style of the K-Bit, and a popularity attribute, wherein the popularity attribute comprises the number of visits to the K-Bit by users of the education system and the number of times the K-Bit is listed as a user favorite by users of the education system.

4. The education system of claim 3, wherein K-Bit type attributes comprise introduction, definition, application, practice, proof, simulation, history, and homework type attributes.

5. The education system of claim 1, wherein alternative K-Bits are associated with each of the K-Bits, the alternative K-Bits to provide parallel views of the same topic as an associated K-Bit to support student-centric learning, wherein if a student does not understand the associated K-Bit, one or more of the alternative K-Bits are presented to the student as a parallel view of the associated K-Bit until the student is able to master the topic of the associated K-Bit.

6. The education system of claim 5, wherein the alternative K-Bits are chosen by the online education service based on student profiles, student preferred sources, student learning styles, and an analysis of all K-Bits for that topic in a database of K-Bits.

7. The education system of claim 1, wherein the K-Bit comprises one of text, graphics, video, animation, interactive exercises, practice exercises, simulations, skill reinforcement games, or a combination thereof.

8. The education system of claim 1, further including a filter, wherein K-Bits provided by the community at large are filtered by experts and trusted professionals to block inappropriate K-Bits and certify appropriate K-Bits, wherein experts and trusted professionals grade the content of certified K-Bits to indicate the learning effectiveness of the certified K-Bit.

9. The education system of claim 1, wherein a collection of K-Courses, K-Lessons, and K-Bits created by the same person or entity are included in a channel, the channel being defined as the person or the entity that created the collection.

10. A method for online education services, comprising:
providing, by a server, a set of web-page templates to capture basic units of knowledge (K-Bits) contributed from a plurality of sources, wherein a structured sequence of K-Bits represent a K-Lesson, the K-Lesson providing a complete lesson for a particular topic, and wherein a structured sequence of K-Lessons represent a K-Course, the K-Course providing a full curriculum on a particular subject;
upon receiving a request for a topic from a student, displaying a K-Bit based on the identified topic to the student for online learning;
until the student is able to grasp the topic of the displayed K-Bit, displaying an alternative K-Bit as a parallel view of the identified topic, wherein the alternative K-Bit is chosen based on the student's profile, learning style, and preferred resources; and
receiving an indication from the student that the topic is understood.

11. The method of claim 10, wherein if the request for a topic comprises a request for a lesson on a topic, the method further comprising:
returning the student to the K-Lesson sequence;
displaying the next K-Bit in the sequence of K-Bits for the K-Lesson;
until the student is able to grasp the topic of the displayed next K-Bit, displaying an alternative K-Bit to the next K-Bit as a parallel view of the identified topic, wherein the alternative K-Bit is chosen based on the student's profile, learning style, and preferred resources; and
upon receiving an indication of understanding of the next K-Bit, repeating the returning process and displaying processes until the K-Lesson is complete.

12. The method of claim 10, wherein each basic unit of knowledge (K-Bit) comprises a single topic having one of a single concept, term or equation.

13. The method of claim 10, wherein experts and trusted professionals are used to block contributed K-Bits found to be inappropriate and certify contributed K-Bits found to be appropriate, wherein experts and trusted professionals grade the certified K-Bits to indicate the learning effectiveness of the certified K-Bit.

14. The method of claim 10, wherein a process for selecting alternative K-Bits for individualized learning comprises:
searching a K-Bit database to identify a list of K-Bits that match the identified topic and attributes of the displayed K-Bit;
providing a value for each identified K-Bit on the list by,
determining a quality rating based on ratings given by previous users of the K-Bit and experts and trusted professionals;
determining relationships between pairs of K-Bits that were selected by the same users;
identifying other users that have general rating and selection patterns similar to the student;
determining a learning style preference and a type attribute preference for the student; and
assigning increased value to preferred sources of sources of content;
ordering the list of K-Bits based on the value provided; and
eliminating any K-Bits from the list that violate an acceptance criterion, wherein an acceptance criterion includes language, grading, certification criteria.

15. The method of claim 10, wherein the K-Bit comprises one of text, graphics, video, animation, interactive exercises, practice exercises, simulations, skill reinforcement gamed, or a combination thereof.

16. The method of claim 10, wherein K-Bit types comprise introduction, definition, application, practice, proof, simulation, history, and homework K-Bit types.

17. A computer readable storage medium comprising logic which, if executed by a processor, causes an education server to:
provide a set of web-page templates to capture basic units of knowledge (K-Bits) contributed from a plurality of sources, wherein a structured sequence of K-Bits represent a K-Lesson, the K-Lesson providing a complete lesson for a particular topic, and wherein a structured sequence of K-Lessons represent a K-Course, the K-Course providing a full curriculum on a particular subject;
upon receiving a request for a topic from a student, display a K-Bit based on the identified topic to the student for online learning;
until the student is able to grasp the topic of the displayed K-Bit, display an alternative K-Bit as a parallel view of the identified topic, wherein the alternative K-Bit is chosen based on the student's profile, learning style, and preferred resources; and
receive an indication from the student that the topic is understood.

18. The computer readable medium of claim 17, wherein the alternative K-Bit is chosen based on student profiles, student preferred sources, student learning styles, and an analysis of all K-Bits for that topic in a database of K-Bits.

19. The computer readable storage medium of claim 17, wherein if the request for a topic comprises a request for a lesson on a topic, the logic further causes the server to:
return the student to the K-Lesson sequence;
display the next K-Bit in the sequence of K-Bits for the K-Lesson;
until the student is able to grasp the topic of the displayed next K-Bit, display an alternative K-Bit to the next K-Bit as a parallel view of the identified topic, wherein the alternative K-Bit is chosen based on the student's profile, learning style, and preferred resources; and
upon receiving an indication of understanding of the next K-Bit, repeat the return process and display processes until the K-Lesson is complete.

20. The computer readable storage medium of 19, wherein the alternative K-Bit is chosen based on student profiles, student preferred sources, student learning styles, and an analysis of all K-Bits for that topic in a database of K-Bits.
